(19) United States
(12) Patent Application Publication
(10) Pub. No.: US 2010/0085938 A1
(43) Pub. Date: Apr. 8, 2010

(54) WiFi network system for performing a high-speed handover of voice and multimedia data and method applied to the same

(75) Inventors: Michael Chen, Hsin-Chu (TW); Ming-Chen Chou, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Kuang Sheng Yun Ltd., Hsin-Chu (TW)

(21) Appl. No.: 12/385,112

(22) Filed: Mar. 31, 2009

(30) Foreign Application Priority Data
Oct. 3, 2008 (TW) 097138094

(51) Int. Cl. H04W 36/00

(52) U.S. Cl. 370/331

(57) ABSTRACT

A WiFi network system for performing a high-speed handover of voice and multimedia data includes a wireless station (STA), a network router for connecting to the Internet; first and second smart base stations respectively connected with the Internet through the network router, wherein the second smart base station is adjacent to the first smart base station. Each of the smart base stations covers an area in order to register the STA located in the area and connect the STA with the Internet through the first or a second smart base station and the network router.

### BACKGROUND OF THE INVENTION

1. Field of the Invention

The present invention relates to a communication system for high-speed handover of voice and multimedia data and, more particularly, to a WiFi network system for performing a high-speed handover of voice and multimedia data and the method applied to the same.

2. Description of Related Art

WiFi networks are designed for personal computers to access data of the Internet, but in application, the base stations do not have the procedure of data processing in real time and at high speed mobility. Thus, a base station in the IEEE 802.11 standard is a very simple access point (AP), without providing router and other functions.

It is an important requirement that voice and multimedia data on voice over Internet protocol (VoIP) at high mobility can be exchanged in real time and at high speed between the base stations, and otherwise the voice packet loss is high or the network connection fails. To achieve this, the simple AP controlled by a central server or control unit is not enough because the central data procedures in the server or control unit need to process hundreds or thousands of requirements for different APs. In this case, the real time is not easily obtained. A current solution uses a public time division multiplexing (TDM) and increases the functions of the central control unit to thereby improve the AP function. However, the moving speed is still lower than 20 km/hr.

FIG. 1 is a configuration of a typical WiFi network. As shown in FIG. 1, the base station uses the very simple access points 121-123 without the routing function. When a wireless station (STA) 11 registers at a first access point (AP) 121, the STA 11 connects through Pass #1 to the first AP 121, the first AP 121 connects through Pass #2 and a router/gateway 13 to the Internet. When the STA 11 moves toward Pass #3, signal received by the first AP 121 is getting smaller until a disconnection occurs (#4). When the STA 11 is far from the first AP 121 to accordingly present a disconnection, it starts to register at a second AP 122 by connecting through Pass #5 to the second AP 122 which in turn connects through Pass #6 and the router/gateway 13 to the Internet. Such a handover process is complete by a long time (around few seconds). Such a long time for the handover process may cause the Internet disconnection on the data accesses, and the data packets will shortly require handover again for Internet accesses. In addition, the voice or multimedia data requires a real-time transmission in order to avoid large amount of packet loss or the Internet disconnection.

To improve the mobility of a WiFi network, an updated version is shown in FIG. 2 in which a central control unit 24 is used after the APs 221 to 223. Handover function is placed in the central control unit 24. The control unit 24 can cover a service area with several hundreds of APs. When the STA 21 registers at the first AP 221, it connects through Pass #1 to the first AP 221 and through Pass #2 to the central control unit 24. The control unit 24 can obtain all connection information of the STA 21 and accordingly connects the router/gateway 23 through Pass #3 to the Internet. When the STA 21 moves toward Pass #4, signal received by the first AP 221 is getting smaller, and the second AP 222 starts to receive a signal sent by the STA 21. The control unit 24 accordingly sends a command to the second AP 222 through Pass #6 in order to ask the second AP 222 to take over the route originally connected to the first AP 221, without asking the STA 21 to register at the second AP 222 again. This networking configuration improves the data handover speed between the base stations (or APs), and for the non-voice and non-multimedia data forwarding, such as a conventional “Internet” data forwarding, in the WiFi network system, the forwarding speed for an Internet access can reach up to 300 km/h. However, the central control unit 24 requires covering the hundreds of APs in the service area, and each of the APs may concurrently offers the STA 21 services. In this case, the control unit 24 has to process many cases at the same time, which causes a low system performance or system disconnection. Also, the operation amount of the STA 21 is rapidly changed in a period, especially in the burst or peak time, and the quality of service (QoS) is rapidly changed without any guarantee. Upon the reasons above, for the moving voice and multimedia data, the optimal moving rate is only up to 20 km/h, and the QoS can be guaranteed only at a speed lower than 10 km/h. When the speed is higher than 20 km/h, the QoS becomes poor.

Therefore, it is desirable to provide an improved WiFi network system for performing a high-speed handover of voice and multimedia data and the method applied to the same to mitigate and/or obviate the aforementioned problems.

### SUMMARY OF THE INVENTION

The object of the present invention is to provide a method and system for WiFi network high-speed mobile voice and multimedia data communication, which can achieve both high moving rate and excellent QoS.

In accordance with one aspect of the invention, there is provided a WiFi network system for performing a high-speed handover of voice and multimedia data, which includes at least one wireless station (STA), a network router for connecting to the Internet; and first and second smart base stations respectively connected to the network router and connected with the Internet through the network router, wherein the second smart base stations are adjacent to the first smart base station. Each of the first and the second smart base stations covers an area in order to register the STA located in the area and connect the STA with the Internet through the first or a second smart base station and the network router. A signal sent by the STA registering at the first smart base station is received by the first smart base station and the second smart base station adjacent to the first smart base station. The second smart base station receives the signal with a second signal strength and reports the second signal strength to the first smart base station. The first smart base station compares a first signal strength received by itself with the second signal strength. When the second signal strength of the second smart base station is greater than the first signal strength over a threshold, the first smart base station sends all registration information of the STA to the second smart base station in order to hand over the STA to the second smart base station. Accordingly, the real-time and high mobility WiFi network is provided.

In accordance with another aspect of the invention, there is provided a method for performing a high-speed handover of voice and multimedia data in a WiFi network system which includes at least one wireless station (STA), a network router for connecting to the Internet; and first and second smart base stations respectively connected with the Internet through the network router, wherein the second smart base station is adjacent to the first smart base station, each of the first and the second smart base stations covers an area for the STA to locate and register and also connect with the Internet through the first or second smart base station and the network server. The method includes the steps of: (A) registering the STA at the first smart base station, connecting the STA to the network server through the first smart base station and then to the Internet through the network server, wherein signal sent by the STA is received by the first and the second smart base stations; (B) the second smart base station receiving the signal with a second signal strength and reporting the second signal strength to the first smart base station; (C) the first smart base station comparing a first signal strength received by itself with the second signal strength; and (D) the first smart base station sending all registration information of the STA to the second smart base station in order to hand over the STA to the second smart base station when the second signal strength of the second smart base station is greater than the first signal strength over a threshold.

Other objects, advantages, and novel features of the invention will become more apparent from the following detailed description when taken in conjunction with the accompanying drawings.

### BRIEF DESCRIPTION OF THE DRAWINGS

FIG. 1 is a configuration of a typical WiFi network;

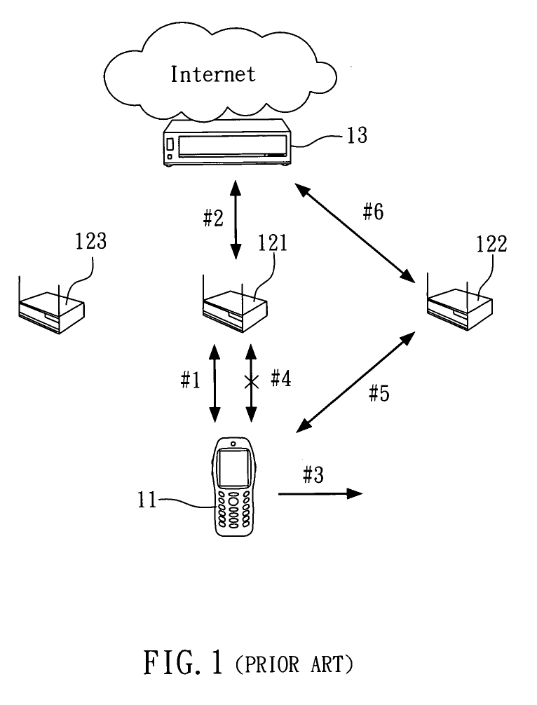

FIG. 2 is a configuration of another typical WiFi network.

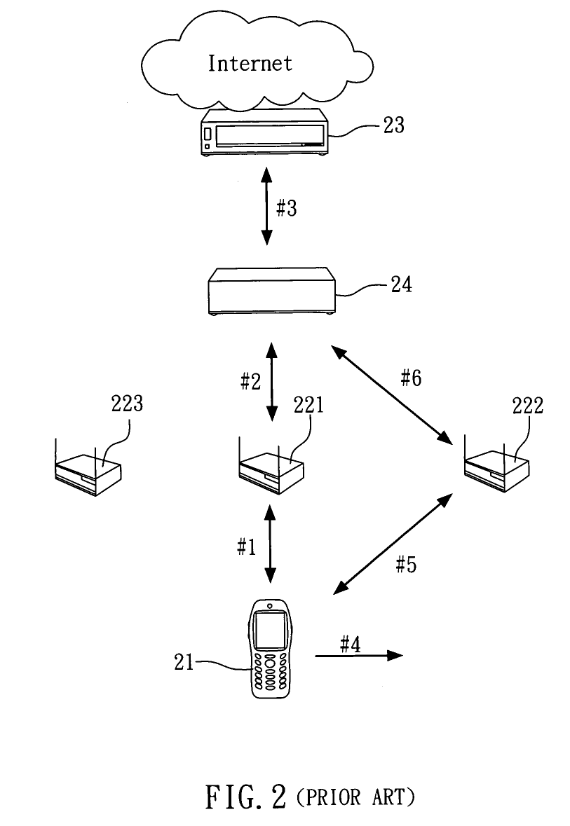

FIG. 3 is a configuration of a WiFi network system for performing a high-speed handover of voice and multimedia data according to an embodiment of the invention; and

FIG. 4 is a flowchart of a method for performing a high-speed handover of voice and multimedia data in a WiFi network system according to an embodiment of the invention.

### DETAILED DESCRIPTION OF THE PREFERRED EMBODIMENT

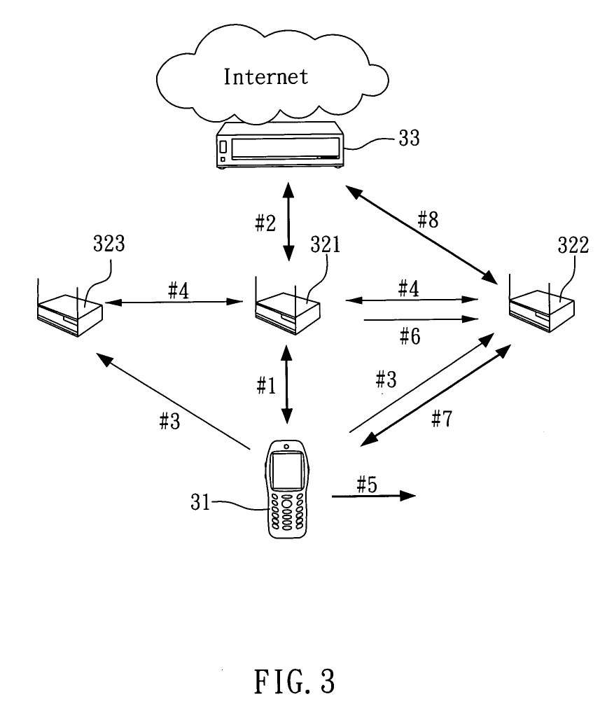

FIG. 3 is a configuration of a WiFi network system for performing a high-speed handover of voice and multimedia data according to an embodiment of the invention. In FIG. 3, the system includes a wireless station (STA) 31, a network server 33 for connecting to the Internet, and smart base stations (SBSs) 321 to 323 which replace the central control unit and simple APs in the prior art, thereby providing high speed handover function and WiFi access point function.

As shown in FIG. 3, when the STA31 registers at the first SBS 321, the STA31 can connect through Pass #1 to the first SBS 321 and then through Pass #2 to the network server 33 and the Internet, and at the same time the second and the third SBSs 322 and 323 adjacent to the first SBS 321 can receive the signals transmitted by the STA 31 through Pass #3. In this case, the first SBS 321 automatically sends a request to the second and the third SBSs 322 and 323 for asking them to report the signal strengths of the signals received through, such as, Pass #4.

When the STA31 moves toward Pass #5, the first SBS 321 senses a change of the signals transmitted by the STA3 1. Accordingly, the first SBS 321 automatically compares the signal strengths reported by the second and the third SBSs 322 and 323 respectively with the signal strength received thereby. Thus, at the time close to the critical point, the first SBS 321 can determine to hand over the control of the STA 31 to which SBS. For example, when the first SBS 321 determines that the signal strength received by the second SBS 322 is greater than that received by itself over a threshold (the difference between first and second signal strengths is larger than the threshold), the second SBS 322 is selected by the first SBS 321 to take over the control of the STA3 1, and in this case the first SBS 321 sends all registration information of the STA31 and hands over the STA31 to the second SBS 322 (through Pass #4). Next, the second SBS 322 connects through Pass #8 to the Internet to complete the handover procedure. Such a configuration does not waste any time and can provide a speed high enough to support a high-speed moving handover.

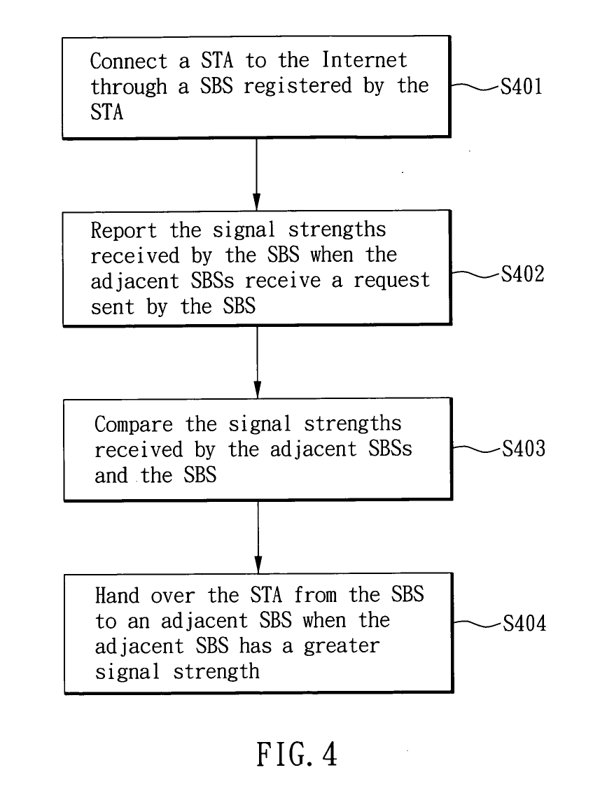

FIG. 4 is a flowchart of a method for performing a high-speed handover of voice and multimedia data in a WiFi network system according to an embodiment of the invention. As shown in FIGS. 3 and 4, the WiFi network system includes a STA 31, a network router 33 for connecting to the Internet, and smart base stations (SBSs) 321 to 323. First, the STA 31 registers at the SBS 321, connects to the router 33 through the SBS 321, and connects to the Internet through the router 33 (S401). Next, the SBSs 322, 323 adjacent to the SBS 321 receive a request sent by the SBS 321 and report the signal strengths of the signals received from the STA 31 to the SBS 321 (S402). The SBS 321 continuously compares the signal strengths reported by the SBSs 322, 323 and received by itself (S403), and hands over the control of the STA 31 to the SBS 322 when the signal strength reported by the SBS 322 is greater than that received by itself over a threshold (the difference between first and second signal strengths is larger than the threshold) (S404). In this case, the connection of the STA 31 is switched from the SBS 321 to the SBS 322, and a high-speed moving handover is complete in the manner above.

Although the present invention has been explained in relation to its preferred embodiment, it is to be understood that many other possible modifications and variations can be made without departing from the spirit and scope of the invention as hereinafter claimed.

What is claimed is:

1. A WiFi network system for performing a high-speed handover of voice and multimedia data, comprising:
at least one wireless station (STA);
a network router for connecting to the Internet; and
first and second smart base stations respectively connected to the network router and connected with the Internet through the network router, the second smart base station being adjacent to the first smart base station, each of the first and the second smart base stations covering an area in order to register the STA located in the area and connect the STA with the Internet through the first or a second smart base station and the network router;
wherein a signal sent by the STA registering at the first smart base station is received by the first smart base station and the second smart base station adjacent to the first smart base station, the second smart base station receives the signal with a second signal strength and reports the second signal strength to the first smart base station, the first smart base station compares a first signal strength received by itself with the second signal strength, and when the second signal strength of the second smart base station is greater than the first signal strength over a threshold, the first smart base station sends all registration information of the STA to the second smart base station in order to hand over the STA to the second smart base station.

2. The system as claimed in claim 1, wherein the first and the second smart base stations contain a WiFi access point function.

3. The system as claimed in claim 1, wherein the STA registers at a closest one among all the smart base stations.

4. The system as claimed in claim 1, wherein the first and the second smart base stations contain a function of automatically sending a message to adjacent smart base stations.

5. The system as claimed in claim 1, wherein the first and the second smart base stations sense a signal change of the STA.

6. The system as claimed in claim 1, wherein the first and the second smart base stations compare the signal strengths received by one another.

7. The system as claimed in claim 1, wherein the first and the second smart base stations contain a function of automatically switching to another smart base station.

8. A method for performing a high-speed handover of voice and multimedia data in a WiFi network system which includes at least one wireless station (STA), a network router for connecting to the Internet; and first and second smart base stations respectively connected to the network router and connected with the Internet through the network router, wherein the second smart base station is adjacent to the first smart base station, each of the first and the second smart base stations covers an area in order to register the STA located in the area and connect the STA with the Internet through the first or a second smart base station and the network router, the method comprising the steps of:
(A) registering the STA at the first smart base station, connecting the STA to the network router through the first smart base station and then to the Internet through the network router, wherein signal sent by the STA is received by the first and the second smart base stations;
(B) receiving the signal with a second signal strength by the second smart base station and reporting the second signal strength to the first smart base station;
(C) comparing a first signal strength received by the first smart base station itself with the second signal strengths; and
(D) sending all registration information of the STA from the first smart base station to the second smart base station in order to hand over the STA to the second smart base station when the second signal strength of the second smart base station is greater than the first signal strength over a threshold.

9. The method as claimed in claim 8, wherein, following the STA moving, the first smart base station in step (C) continuously compares the signal strengths received by itself and the second smart base station.

10. The method as claimed in claim 8, wherein the STA in step (D) is switched to one with the greatest signal strength received among all the smart base stations.
